(19) United States
(12) Patent Application Publication
(10) Pub. No.: US 2011/0042143 A1
(43) Pub. Date: Feb. 24, 2011

(54) METHOD AND APPARATUS FOR INTENSIFYING ORE PROSPECTING

(75) Inventors: Ilpo Auranen, Espoo (FI); Jukka Raatikainen, Espoo (FI)

Correspondence Address: OLIFF & BERRIDGE, PLC, P.O. BOX 320850, ALEXANDRIA, VA, 22320-4850, US

(73) Assignee: MINE ON-LINE SERVICE OY, Espoo (FI)

(21) Appl. No.: 12/867,666

(22) PCT Filed: Feb. 16, 2009
(86) PCT No.: PCT/FI2009/050122

§ 371 Date: Oct. 29, 2010

(30) Foreign Application Priority Data
Feb. 15, 2008 (FI) 20080119

(51) Int. Cl. E21B 49/00; G01N 23/223

(52) U.S. Cl. 175/58; 378/45

(57) ABSTRACT

A method and an apparatus for intensifying ore prospecting, a core (1) and/or drill cuttings sample being analyzed in said method, whereby the analysis of the sample (1) is performed with a movable analysing apparatus (4, 7) on the drilling site of the sample or in the vicinity thereof after the sample to be analyzed has been drilled.

The present invention relates to intensifying of ore prospecting. More precisely, the invention relates to a method and an apparatus to be used for ore prospecting and analyzing of the ore content, in order to intensify these procedures.

Ore prospecting in this connection refers to analyzing of elements, minerals, rock types etc. in the bedrock.

Ore prospecting is usually implemented nowadays by locating first the position of the potential ore deposit with different methods, and after that by starting a more accurate analysis of the bedrock in order to determine the ore grade and the more accurate location of the ore deposit. This more accurate analysis of the bedrock utilizes core samples drilled from the rock, or alternatively samples taken from the powder generated by drilling, in other words the so called drill cuttings.

Sampling boreholes to be drilled into the bedrock are drilled as a square grid with predetermined distances from each other, and the drilled samples, either cores or drill cuttings samples, are delivered to be further processed and analyzed.

When drilling a core sample, the core is first cut to lengths of about 1 meter, and the core lengths are stored in core boxes. The cores are delivered in the core boxes to further processing in a laboratory, where the core is first halved, and one half of the core sample is archived. The other half of the cut lengths of the core are first crushed as lengths of 1-5 m to a powder, the crushed powder being after that dried and homogenized. A required quantity of this homogenized powder is then taken in order to form a sample briquette, based on which the ore content of the sample will be analyzed.

The duration of the traditional analysis from drilling the core to receiving the results of the analysis is usually from about 1 to 6 months.

A drill cuttings sample is prepared so that when boring a hole into the rock, the drill cuttings are flushed either with air or water out from the drill hole, and a part of this drill cuttings flushed out is taken into a sample bag. Usually drill cuttings per each 1 meter advance of the borehole are collected in one sample bag, and the sample bag is changed every one meter advance into new, whereby samples can be collected from each meter of the borehole.

Drill cuttings sample bags are delivered to a laboratory to be analyzed, where the drill cuttings of the bag are first dried and homogenized, and then a sample briquette is formed thereof for the analysis,

Analyzing of the drill cuttings sample takes usually as long as that of a core sample, but the percussion drilling of the drill cuttings sample is much quicker than the drilling of the core. A drill cuttings sample, however, does not give the corresponding information on the structure of the drilled bedrock that can be gained by investigating a core.

By means of the present invention, the analyzing of a core and drill cuttings can be substantially accelerated, whereby the analysis results of the sample will be available in about 1-3 days. This provides a lot of advantages compared to the methods known in the art, especially due to the significant savings in time. One of the advantages is controlling of the sample drilling based on the analysis results of the samples.

In the solution in accordance with the invention, the sample is also examined non-destructively or without homogenizing it, whereby the sample is also available for other analyses in its original condition and the results of the analyses are much more useful. The solution in accordance with the invention provides specifically more accurate location information on the analysis than what is possible from a sample analyzed with a traditional destructive sample analysis. Thereby useful additional information for example on the micro structure of the rock can be gained.

In the solution according to the invention, the drilled core or drill cuttings sample is analyzed at the sampling site or in the vicinity thereof, like in the core storage, substantially immediately after the sampling action by using a movable analyzing apparatus that analyzes the sample with one or more non-destructive methods. After analyzing, the results of the analysis are transmitted to the ore prospecting organization that based on the collected results of sample analyses is able to make the decisions required either to continue the process or to interrupt it on the examined area.

More precisely, the method in accordance with the present invention is characterized by what is stated in the characterizing part of Claim 1, and the apparatus in accordance with the invention is characterized by what is stated in the characterizing part of Claim 8.

The solution according to the invention will be described in more detail in the following by way of example, with reference to the enclosed drawings, wherein

FIG. 1 shows schematically one solution according to the invention for analyzing a core,

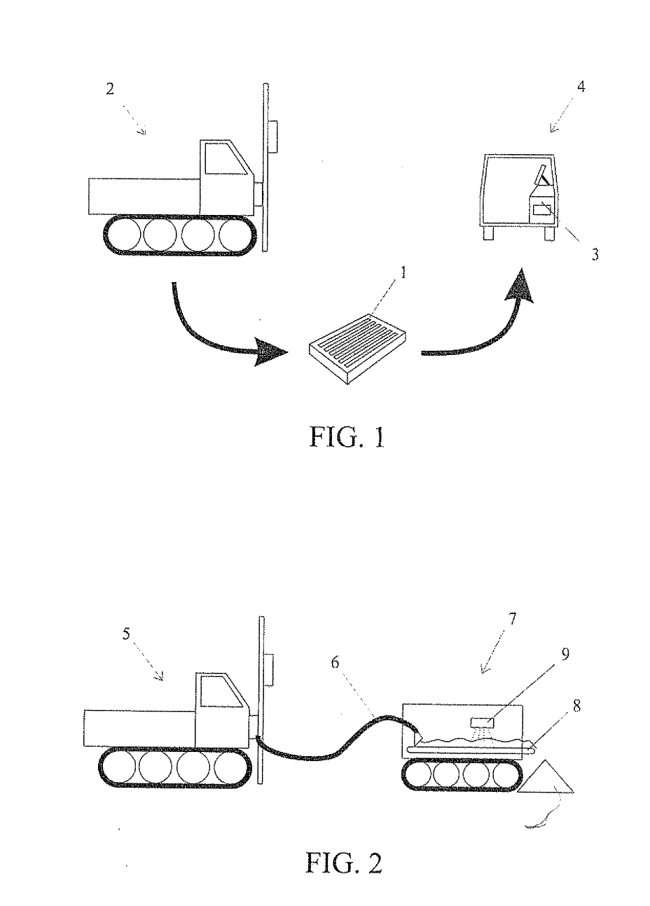

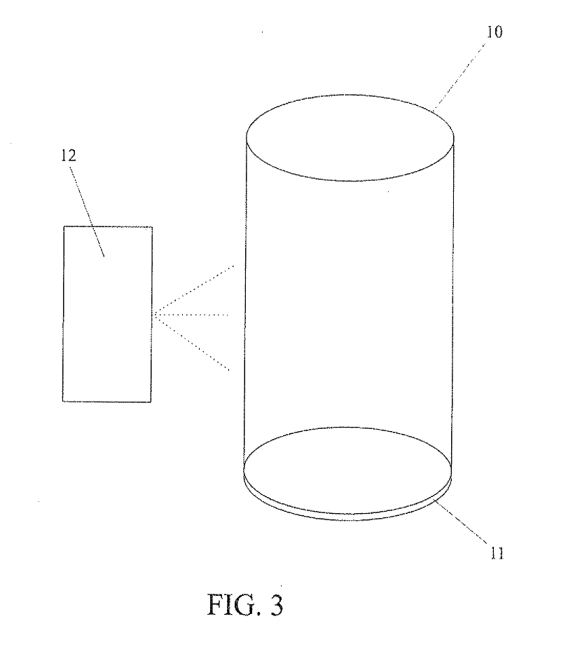

FIG. 2 shows schematically one solution according to the invention for analyzing drill cuttings, and

FIG. 3 shows schematically one alternative solution according to the invention for analyzing drill cuttings.

In the solution illustrated in FIG. 1, the core 1 is drilled from a rock by means of appropriate drilling equipment 2. Usually, the core 1 is cut into pieces of a suitable length, like samples having a length of 1 m. When the core 1 is prepared and removed from the drilling device 2, it will be analyzed with analyzing apparatus 3 brought to the mineral prospecting site. In the example of FIG. 1, the analyzing apparatus 3 is located in the rear compartment of a van 4.

Location position data of the drilled core 1 is determined in a way known in the art, whereby the location of the borehole is determined by means of GPS or other corresponding location positioning system, and the depth data of the sample is determined based on the distance of the drill bit in the drilling equipment 2. This location positioning data can be forwarded to the analyzing apparatus 3 electrically or in a traditional way, whereby the location positioning data first is recorded in the core boxes and then manually entered into the analyzing apparatus when analyzing the samples.

The core 1 is analyzed by feeding the core through the analyzing apparatus 3. There the analyzing apparatus 3 analyzes the core I with a non-destructive analyzing method like X-ray, laser, hyperspectral and/or digital imaging.

The results of analyses collected by the analysing apparatus 3 are preferably in an electronic form, whereby the information can be transmitted electrically with a data communication means like 3G, GSM or other corresponding network to the ore prospecting organization that based on the results is able to determine for example the next core drilling hole location to be placed. Said data communication means are preferably included in the analyzing apparatus 3 or the van 4 transporting the same.

In addition to cores, also drill cuttings samples can be analyzed by means of the apparatus according to FIG. 1.

FIG. 2 shows a schematic view of one solution according to the invention for analyzing the drill cuttings generated by drilling of the rock. In the example of FIG. 2, a usual borehole is drilled to the rock with drilling equipment 5 having a significantly higher drilling speed than when drilling a core. In connection with the drilling action, the drill cuttings generated by the drilling are all collected and transported from the drilling equipment 5 through a pipe 6 to a movable analyzing apparatus 7 located in the vicinity of the drilling equipment. The drill cuttings delivered to the analyzing apparatus 7 are dropped onto a conveyor 8 included in the analyzing apparatus, said conveyor transporting in a continuous manner drill cuttings under an analyzer 9. The analyzer 9 analyzes in a continuous manner the flow of the drill cuttings passing under the analyzer. After being analyzed, the drill cuttings are conveyed on the conveyor out from the analyzing apparatus 7 for example to a heap nearby the drilling area. The location positioning data of the drill cuttings sample is determined in a substantially corresponding way as in the location positioning of the core described in the example of FIG. 1.

In the solution according to the example of FIG. 2, the analyzer 9 analyzes drill cuttings with a method based on X-ray fluorescence, where X-ray is radiated continuously or as pulses to the drill cuttings resting on the conveyor 8, and based on the ray reflected from the drill cuttings, the proportions of elements, minerals etc. in the drill cuttings are determined. The analyzer 9 can also be an analyzer based on laser or hyperspectral imaging or a combination of several different types of analyzers.

The solution shown in FIG. 3 is advantageously used for analyzing drill cuttings immediately after the drill cuttings have been flushed from the borehole to be drilled. In the solution of FIG. 3, the drill cuttings are led to an open-top, transparent receiver cylinder 10, having its bottom closed with a hatch 11. When the cylinder 10 is filled by the drill cuttings either totally or up to a predetermined level, the drill cuttings sample is analyzed with an analyzer 12. After the drill cuttings sample has been analyzed, the receiving cylinder is emptied by opening the hatch 11, whereby the drill cuttings drop out from the receiver cylinder. Immediately when the receiver cylinder 10 is empty, the hatch 11 is closed again, whereby new drill cuttings start to be collected again to the receiver cylinder. This cycle is repeated during the whole drill cuttings drilling, whereby the generated drill cuttings or at least a part of them could be analyzed in essentially real time and the analyzing results are available immediately after the drilling.

The analysis information collected with the solution according to the invention can be advantageously used for working out an ore map or block model of the orebody, based on which a mine eventually to be built in the ore prospecting area can be planned and implemented.

The solution according to the invention does not have to be implemented as a separate analyzing unit, as described in the examples of FIGS. 1 and 2, but it can also be advantageously integrated as a part of the drilling equipment, whereby it is easy to transfer the sample to be analyzed immediately after the drilling and it can be for example automated.

Among others, the following advantages are provided by the solution in accordance with the invention:
Ore prospecting can be essentially accelerated, because the sample analysis results are available significantly faster than with the solutions of prior art.
Analyzing of the samples can be implemented on the ore prospecting site or nearby.
Unnecessary drilling works can be eliminated.
Geologist interpreting the analysis results can work remote and control multiple different sampling sites simultaneously.
Shorter analyzing cycle times enabled by the solution according to the invention give more accurate information on the rock structures, whereby among others a more accurate determination of the ore boundary and the determination of the micro structure of the rock can be made cost-effectively.
Total costs of the ore prospecting can be significantly decreased.
One and the same apparatus can be used for analyzing both core and drill cuttings samples.

1. A method for intensifying ore prospecting, a core and/or drill cuttings sample being analyzed in said method, wherein the analyzing of the sample is performed on the drilling site of the sample or in the vicinity thereof with a movable analyzing apparatus, with a method based on X-ray fluorescence, after the sample has been drilled.

2. A method according to claim 1, wherein the analyzing apparatus is integrated as a part of drilling equipment forming the sample.

3. A method according to claim 1, wherein the analyzing of the samples is implemented with a non-destructive analyzing method.

4. A method according to claim 3, wherein the samples are additionally analyzed with laser, hyperspectal and/or digital imaging.

5. A method according to claim 1, wherein the analysis results of the samples are transmitted electrically from the analyzing apparatus to further analyses.

6. A method according to claim 1, wherein the sampling action is controlled based on the analysis results.

7. A method according to claim 1, wherein an ore map and/or a block model of the ore body are worked out based on the analysis results.

8. An apparatus for intensifying ore prospecting, said apparatus comprising means for analyzing a core and/or drill cuttings sample, wherein said means are an integrated part of an analysing apparatus movable to the drilling site of the sample or to the vicinity thereof, and that said means comprise an X-ray analyzer.

9. An apparatus according to claim 8, wherein the analyzing apparatus is integrated as a part of drilling equipment preparing the sample.

10. An apparatus according to claim 8, wherein the analyzing apparatus comprises means for transmitting the analysis results electrically outside the analyzing apparatus.

11. An apparatus according claim 8, wherein the means for analyzing the sample additionally comprise a laser analyzer, hyperspectral and/or digital camera.
